(19) United States
(12) Patent Application Publication
(10) Pub. No.: US 2017/0027148 A1
(43) Pub. Date: Feb. 2, 2017

(54) Horseshoe and Fastening Mechanism, and Method of Use Thereof

(71) Applicant: PLASTIC HORESHOES PTY LTD, Northgate (AU)

(72) Inventor: Steve Costin, Veresdale (AU)

(73) Assignee: PLASTIC HORESHOES PTY LTD, Northgate (AU)

(21) Appl. No.: 15/304,022

(22) PCT Filed: Apr. 14, 2015
(86) PCT No.: PCT/AU15/50171

§ 371 Date: Oct. 13, 2016

(30) Foreign Application Priority Data
Apr. 14, 2014 (AU) 2014901354

(51) Int. Cl. A01L 1/02; A01L 7/02; A01L 3/02

(52) U.S. Cl. CPC A01L 1/02; A01L 3/02; A01L 7/02

(57) ABSTRACT

The present invention relates to a horseshoe assembly including a horseshoe, a fastening mechanism and a flowable shock absorber, the horseshoe defining at least one channel on a hoof engaging face of the horseshoe and at least one injection port on the ground engaging face of the horseshoe, and a method of using the horseshoe assembly.

### TECHNICAL FIELD

The present invention relates to a horseshoe, a fastening mechanism, an assembly and kit including the horseshoe and fastening mechanism, and a method of using the horseshoe and fastening mechanism.

### BACKGROUND

Horseshoes are attached to a horse's hooves to protect the hooves from wear. According to current practice, each horseshoe is nailed to a horse's hoof with one or more nails, which are driven through the horseshoe and the insensitive hoof until the nails emerge through the upper side of the hoof. The tip of the emerging end of each is nail is then twisted or clipped-off and the remaining portion is clinched or bent over against the hoof to ensure the nail is able to hold the shoe in place.

A problem with the above-described current practice is that a wayward nail can be driven too close or slightly into a sensitive part of the horse's foot. Typically, a wayward nail will cause a horse to go lame at once or after some days.

A further problem with current practice is that a horse that is regularly shod suffers significant damage and weakening of the outer hoof wall due to past nail holes. The outer hoof wall of such a horse is prone to chipping, cracking and general deterioration, which, apart from severely impacting on the future re-shoeing of the hoof due to the absence of healthy hoof wall for the positioning of nails, can, in some cases, lead to the horse becoming temporarily lame.

With current practice, there are restrictions as to where the nails can enter a hoof. Typically, horseshoes are only nailed to an outer hoof wall at a front toe portion and an intermediate quarter portion (i.e., the widest part) of the hoof where the nails are able to emerge through an upper side of the hoof and be clinched. This is not possible at a rear heel portion of the hoof.

Also, due to the common use of relatively rigid metallic horseshoes, horseshoes are only nailed to the toe and quarter portions of a hoof so as not to completely obstruct or impair natural lateral flexing and widening of the hoof when loaded. This natural lateral flexing and widening of the hoof primarily occurs at the heel portion of the hoof and is part of a horse's natural ability to absorb shocks. The use of relatively rigid metallic horseshoes already somewhat impedes this natural movement.

A problem associated with the current practice of leaving the heel portion of a hoof free to flex relative to the heel engaging portion of a horseshoe is that the flexing causes the heel of the hoof to wear resulting in incomplete contact between the hoof and horseshoe. This in turn can cause an exaggerated load on the nails at the toe and quarter portions of the hoof.

For the above reasons, horseshoes have been used that are formed from plastic or other synthetic materials, which are able to provide some shock absorption over metallic horseshoes. However, due to the flexibility of such horseshoes and the inability to nail the horseshoes to a heel portion of a hoof, they typically include a stabilisation bar or member connecting the respective heel engaging portions. This stabilisation bar or member again, however, results in an obstruction or impairment of the natural lateral flexing and widening of the hoof when loaded.

### SUMMARY OF INVENTION

Embodiments of the present invention provide a horseshoe, a fastening mechanism, an assembly and kit including the horseshoe and fastening mechanism, and a method of using the horseshoe and fastening mechanism, which may minimize or overcome at least one of the problems mentioned above, or which may provide the public with a useful or commercial choice.

According to a first aspect of the present invention, there is provided a horseshoe assembly including:

a horseshoe attachable to a hoof of a horse and adapted to allow lateral flexing and widening of the hoof; and

a fastening mechanism for fastening the horseshoe to at least a toe portion and a heel portion of the hoof, the fastening mechanism including mechanical fasteners.

In one form, there is provided a kit including:

at least one horseshoe attachable to a hoof of a horse and adapted to allow lateral flexing and widening of the hoof; and

a fastening mechanism for fastening the at least one horseshoe to at least a toe portion and a heel portion of the hoof, the fastening mechanism including mechanical fasteners.

In another form, there is provided a fastening mechanism for use with a horseshoe attachable to a hoof of a horse and adapted to allow lateral flexing and widening of the hoof, said fastening mechanism being adapted to fasten the horseshoe to at least a toe portion and a heel portion of the hoof and including mechanical fasteners.

In another form, there is provided a horseshoe for use with or when used with the fastening mechanism described above, said horseshoe being attachable to a hoof of a horse and adapted to allow lateral flexing and widening of the hoof.

According to a second aspect of the present invention, there is provided a horseshoe assembly including:

a horseshoe attachable to a hoof of a horse, said horseshoe defining at least one channel in a hoof engaging face of the horseshoe and at least one injection port in a ground engaging face of the horseshoe in fluid communication with the at least one channel;

a fastening mechanism for fastening the horseshoe to the hoof and a flowable shock absorber formulated to be injected into the at least one channel via the at least one injection port once the horseshoe has been fitted to the hoof.

In one form, there is provided a kit including:

a horseshoe attachable to a hoof of a horse, said horseshoe defining at least one channel in a hoof engaging face of the horseshoe and at least one injection port in a ground engaging face of the horseshoe in fluid communication with the at least one channel;

a fastening mechanism for fastening the horseshoe to the hoof; and

a flowable shock absorber formulated to be injected into the at least one channel via the at least one injection port once the horseshoe has been fitted to the hoof.

In another form, there is provided a horseshoe attachable to a hoof of a horse for use with a flowable shock absorber, said horseshoe defining at least one channel in a hoof engaging face of the horseshoe and at least one injection port in a ground engaging face of the horseshoe in fluid communication with the at least one channel, said at least one channel configured to receive the flowable shock absorber via the at least one injection port once the horseshoe has been fitted to the hoof.

In another form, there is provided a flowable shock absorber for use or when used with the horseshoe described above, said flowable shock absorber being formulated to be injected into the at least one channel via the at least one injection port once the horseshoe has been fitted to the hoof.

The horseshoe may be of any size, shape and construction suitably adapted to be attached to the hoof of a horse. For instance, the horseshoe may be circular or semicircular. Typically, however, the horseshoe may have the shape of a conventional horseshoe; that is, a band of material in the form of an extended circular arc attachable to the outer hoof wall of a horse. The horseshoe may be of unitary construction or may be formed from two or more horseshoe pieces.

Likewise, the horseshoe may be formed from any suitable material or materials to protect the hoof of the horse from wear. For instance, the horseshoe may be formed from a metal or synthetics material. The metal may include iron, aluminium, magnesium, titanium or copper, or any alloy thereof, such as steel. The synthetic material may include a rubber or plastics material.

In one aspect of the present invention, the horseshoe may be formed from any suitable material or materials to allow lateral flexing and widening of the hoof when loaded. In this regard, the horseshoe may be formed from a synthetic material or a metal-synthetic material composite. Again, the metal may include iron, aluminium, magnesium, titanium or copper, or any alloy thereof, such as steel. The synthetic material may include a rubber or plastics material, preferably polyurethane.

The horseshoe may have a ground engaging face and an opposed hoof engaging face, and may include a plurality of apertures spaced along a length of the horseshoe for receiving mechanical fasteners for attaching the horseshoe to a hoof.

The apertures may be spaced along the length of the horseshoe in any suitable arrangement that facilitates in the secure fastening of the horseshoe to a hoof with mechanical fasteners. For instance, the apertures may be arranged to facilitate fastening of the horseshoe to at least the toe and heel portions of the hoof, preferably a quarter portion of the hoof as well.

Typically, the apertures may be aligned and spaced along the length of the horseshoe in an arc with a degree of curvature similar to or the same as that of the horseshoe. Each horseshoe may include between 1 and 14 apertures, between 4 and 12 apertures, between 6 and 10 apertures or between 8 and 10 apertures.

Each aperture may extend through both the ground and hoof engaging faces and may include an entrance opening on the ground engaging face and a corresponding exit opening on the hoof engaging face.

Preferably, the entrance opening of each aperture may be countersunk such that, in use, the head of a mechanical fastener received through the aperture may at least sit flush with the ground engaging face.

More preferably, the entrance openings of the apertures may be located in at least one channel or trench (also known as a “fuller”) that is defined in and extends in an arc along the ground engaging face of the horseshoe, preferably with a degree of curvature similar to or the same as that of the horseshoe. The at least one channel or trench may be of any suitable depth that allows the head of a mechanical fastener received through the aperture to at least sit flush with the ground engaging face. The at least one channel or trench may have a depth ranging between 1 and 10 mm, 1.5 and 8 mm, 1.75 and 6 mm or 2 and 4 mm. Preferably, the at least one channel may have a depth of about 3 mm.

The ground engaging face may further include tread and/or protrusions (also known as “caulkins”, “caulks” or “calks”) to provide additional traction. In one embodiment, the ground engaging face may include an outwardly extending rim or edge extending at least partway around the at least one channel or trench.

Additionally, the horseshoe may include one or more portions having a raised outer rim or edge (also known as a “clip”) configured to lie or abut against an upper hoof surface and facilitate in the fitting and positioning of the horseshoe on a hoof. Each clip may be located at any suitable location along a length of the horseshoe such that it may engage with the upper surface of the hoof located at any one of the toe, quarter and heel portions of the hoof.

Typically, the horseshoe may include between 1 and 5 clips spaced around an outer edge of the horseshoe. Preferably, the horseshoe may include three or four clips positioned to, in use, engage the upper surface of the hoof at the toe and quarter portions of the hoof.

As discussed above, the horseshoe may be fastened to the hoof of a horse by mechanical fasteners. Additionally, however, the fastening mechanism may include a chemical fastener such as an adhesive. In this regard, any suitable adhesive may be used that is capable of securely fastening the horseshoe to the hoof. Typically, the adhesive may be an acrylic- or urethane-based adhesive, such as, e.g., Vettec™ Adhere™. Preferably, the adhesive may further include a fungicidal agent and/or bactericidal agent.

In one aspect of the present invention, the assembly, kit or horseshoe may include a shock absorber capable of being placed between the horseshoe and the hoof to provide shock absorption. The shock absorber may be of any suitable form capable of being received between the horseshoe and the hoof and not disrupt the fastening of the horseshoe to the hoof. For example, the shock absorber may be in the form of a pad, preferably a gel pad. Typically, however, the shock absorber may be a flowable shock absorber such as foaming or non-foaming gel, preferably a non-foaming gel, such as, e.g., Vettec™ Equi-Pak™ or SilPak™.

Typically, the hoof engaging face of the horseshoe may further define at least one channel to facilitate in the distribution of the chemical fastener and/or the flowable shock absorber between the hoof and the horseshoe. The at least one channel may of any suitable size and shape to, in use, facilitate distribution of the chemical fastener and/or the flowable shock absorber across at least a portion of the hoof engaging face, typically after the horseshoe has already been at least fitted to the hoof, preferably fastened to the hoof with one or more mechanical fasteners.

The at least one channel may extend across at least the toe engaging portion of the horseshoe, preferably the toe and quarter engaging portions of the horseshoe, more preferably the toe, quarter and heel engaging portions of the horseshoe. Alternatively, the at least one channel may extend across at least the heel engaging portion of the horseshoe, preferably the heel and quarter engaging portions of the horseshoe, more preferably, the heel, quarter and toe engaging portions of the horseshoe.

The at least one channel may extend along a length of the horseshoe in any suitable manner. For instance, the at least one channel may zigzag across a length of the hoof engaging face of the horseshoe, or the at least one channel may extend along the length of hoof engaging face of the horseshoe in a curvilinear manner.

Preferably, the at least one channel may extend at least partway along a length of the horseshoe in an arc with a degree of curvature similar to or the same as that of the horseshoe. In this arrangement, the at least one channel may or may not extend between the aligned apertures. More preferably, the at least one channel may run parallel or concentrically with the apertures aligned and spaced along the length of the horseshoe.

In one embodiment, the at least one channel may extend at least partway along the length of the horseshoe near or along an inner edge of the horseshoe such that chemical fastener and/or the flowable shock absorber received in the channel may escape via the inner edge of the horseshoe.

The at least one channel may have a substantially U- or V-shaped profile or cross-section, preferably U-shaped. The at least one channel may have a width at the hoof engaging surface of about 6 mm, 8 mm, 10 mm, 12 mm or 14 mm, preferably 10 mm, and may taper to a width, if V-shaped, of less than about 5 mm at a bottom of the channel. The at least one channel may have a depth ranging between 1 and 10 mm, 1.5 and 8 mm, 1.75 and 6 mm or 2 and 5 mm. Preferably, the at least one channel may have a depth of at least about 1 mm.

In one embodiment, the hoof engaging face of the horseshoe may include two or more channels for distributing chemical fastener and/or flowable shock absorber. The two or more channels may be distinct separate channels extending across the hoof engaging face of the horseshoe or may intersect at one or more points. If the two or more channels are distinct, the channels may be serially aligned end to end or may be arranged parallel to one another. Additionally, separate channels may be designated for receiving chemical fastener and flowable shock absorber or each channel may receive a mixture of the chemical fastener and the flowable shock absorber.

Each channel may be in fluid communication with at least one injection port accessible from the ground engaging face of the horseshoe for injecting chemical fastener into the channel once the horseshoe has already been mechanically fastened to the hoof. The at least one injection port may be of any suitable size, shape and configuration. For instance, each end of a channel may be in the form of an injection port or each open end of a channel may serve as an injection port. Typically, the at least one injection port may be suitably adapted to at least partially receive chemical adhesive or flowable shock absorber provided in a syringe dispenser.

The at least one injection port may be located in any suitable location on the ground engaging surface of the horseshoe that is accessible. Typically, the at least one injection port may be located, in use, directly below the at least one channel. The at least one injection port may or may not be located in the at least one channel or trench defined in the ground engaging surface, which may or may not substantially align or overlap with the at least one channel defined in the hoof engaging face of the horseshoe.

The horseshoe may include more than one injection port. If the horseshoe contains more than one injection port, alternate injection ports may be used to inject chemical fastener and flowable shock absorber or not. Ultimately, the number of injection ports will be dependent upon the size of the horseshoe. Typically, however, the horseshoe may include about 2, 4, 6, 8 or 10 injection ports.

The mechanical fasteners may be of any suitable size, shape and construction and formed from any material or materials suitably adapted to fasten the horseshoe to the hoof. For example, each mechanical fastener may be in the form of a nail, a screw or a rivet, preferably a metal nail, screw or rivet, more preferably a steel nail, screw or rivet.

In one aspect of the present invention, the mechanical fasteners may be conventional horseshoe nails for fastening the horseshoe to the hoof at a toe and/or a quarter portion of the hoof.

In another aspect of the present invention, the mechanical fasteners may be in the form of a screw or nail of a length suitably adapted to fasten the horseshoe to at least the toe and heel portions of the hoof.

If the mechanical fastener is in the form of a screw, the screw may include any screw of suitable length adapted to fasten the horseshoe to the hoof of a horse and yet not emerge from an upper side of the hoof. Preferably, the screw may be a self-tapping screw, more preferably a 6 g×18 mm self-tapping screw.

Preferably, however, the mechanical fastener may be in the form of a nail. In this regard, the mechanical fastener may be of a length and shape such that in use the mechanical fastener does not need to be clinched and does not emerge from an upper side of the hoof. Typically, the mechanical fastener may have a length of between 15 and 50 mm, between 15 and 40 mm or between 15 and 30 mm, preferably between 15 and 25 mm.

The mechanical fastener may include a shank, an enlarged head at one end of the shank, a pointed end at the other end of the shank and at least one retention member extending from a side of the shank.

As with conventional horseshoe nails, the pointed end of the mechanical fastener may be sized and shaped such that it may pass through an aperture of the horseshoe and be driven into the hoof of the horse. Likewise, the enlarged head of the mechanical fastener may be sized and shaped such that it may not pass through the aperture but may abut against the ground engaging face of the horseshoe to thus securely fasten the horseshoe to the hoof of the horse.

Preferably, the enlarged head of the mechanical fastener may be sized and shaped to, in use, sit substantially flush within the at least one channel or trench defined in the ground engaging face of the horseshoe in which the entrance openings of the apertures may be located. In this regard, the enlarged head of the mechanical fastener may be substantially rectangular in shape.

Adjacent the enlarged head, the mechanical fastener may further include a neck portion, which may taper in thickness from the enlarged head to the shank. In use, the neck portion may be configured to be wedged in an aperture of the horseshoe when the mechanical fastener is driven into the hoof of a horse.

The at least one retention member may be of any size and shape to facilitate in retaining the mechanical fastener in the hoof of the horse and eliminate the need to clinch the mechanical fastener. Put another way, the retention member may be of any suitable size and shape to, in use, not impede insertion of the mechanical fastener into the hoof via an aperture but retain or prevent retraction or withdrawal of the mechanical fastener from the hoof.

Typically, the retention member may be in the form of at least one barb, spike or projection located at or near the pointed end of the mechanical fastener. Preferably, the at least one barb, spike or projection may expand from the pointed end or forward end of the mechanical fastener to a point that is rearwardly facing or at least orthogonally positioned relative to a longitudinal axis of the mechanical fastener.

In one embodiment, the mechanical fastener may include at least two retention members in the form of a pair of barbs, spikes or projections located on opposite sides of the mechanical fastener at or near the pointed end of the mechanical fastener.

In another embodiment, the mechanical fastener may include at least four retention members in the form of two pairs of barbs, spikes or projections serially positioned along a length of the mechanical fastener. A first pair of barbs, spikes or projections located on opposite sides of the mechanical fastener may be located at or near the pointed end of the mechanical fastener. A second pair of barbs, spikes or projections located on opposite sides of the mechanical fastener may be adjacently positioned relative to the first pair. The barbs, spikes or projections of the second pair may have the same orientation as the barbs, spikes or projections of the first pair or not, preferably the same.

The mechanical fastener may be formed by any suitable means. For instance, each mechanical fastener may be formed by casting or by being punched from a rolled strip or bar of metal.

Preferably, however, each mechanical fastener may be formed by being cut from plate metal. More preferably, each mechanical fastener may be laser cut from plate steel. The plate metal or steel may be of any suitable thickness. For instance, the plate metal or steel may be about 1, 2, 3, 4, 5, 6, 7, 8, 9 or 10 mm in thickness, preferably about 3 mm in thickness.

Consequently, the mechanical fastener may be substantially flat or planar in a first orientation and not flat or planar in a second orientation when rotated 90 degrees around its longitudinal axis relative to the first orientation. In the first orientation, the mechanical fastener may have two opposed surfaces substantially parallel to one another and interconnected by opposing edge portions. Preferably, the opposing edge portions in the second orientation may define the shank, the enlarged head, the pointed end and the at least one retention member extending from a side of the shank.

A person skilled in the art will appreciate that the mechanical fastener described above may equally be used to fasten metallic horseshoes, such as aluminium or steel horseshoes, to a toe portion and/or a quarter portion of a horse's hoof.

In a third aspect of the present invention, there is provided a method of shoeing a horse using the horseshoe as hereinbefore described, said method including:

fastening the horseshoe to a hoof of the horse.

The method may include one or more features or characteristics of the horseshoe or the fastening mechanism as hereinbefore described.

For example, the fastening may further include aligning the horseshoe to the outer hoof wall and fixing the horseshoe in place with mechanical fasteners driven through at least the toe portion of the hoof, preferably through the quarter portion of the hoof as well, more preferably through the heel portion of the hoof as well.

For example, the fastening may further include injecting a chemical fastener or a flowable shock absorber between the hoof and the horseshoe via the at least one injection point accessible from the ground engaging face of the horseshoe.

The chemical fastener may be used in conjunction with mechanical fasteners. For example, chemical fastener may be used to fasten the horseshoe to the heel portion of the hoof while mechanical fasteners may be used to fasten the horseshoe to the toe and/or quarter portions of the hoof or visa versa.

Chemical fastener or flowable shock absorber may also be used in conjunction with mechanical fasteners when the hoof of the horse being shoed is of poor quality or quantity (i.e., extensive hoof wall separations or loss, white line disease, anaerobic bacteria, seedy toe, damage or injury to the hoof wall, or thin, shelly, brittle hoof wall).

The method may further include an initial step of preparing the hoof for shoeing by cleaning the hoof and trimming the outer hoof wall.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIGS. 1A and 1B respectively show a ground-engaging surface and a hoof-engaging surface of a horseshoe according to an embodiment of the present invention;

FIG. 2 shows a side view of a mechanical fastener according to an embodiment of the present invention;

FIG. 3 shows a side view of a mechanical fastener according to another embodiment of the present invention;

FIGS. 4A and 4B respectively show a ground-engaging surface and a hoof-engaging surface of a horseshoe according to another embodiment of the present invention; and

FIG. 5 is an X-ray image of a hoof of a horse fitted with the horseshoe, as shown in FIGS. 1A and 1B, and mechanical fasteners according to another embodiment of the present invention.

### DETAILED DESCRIPTION

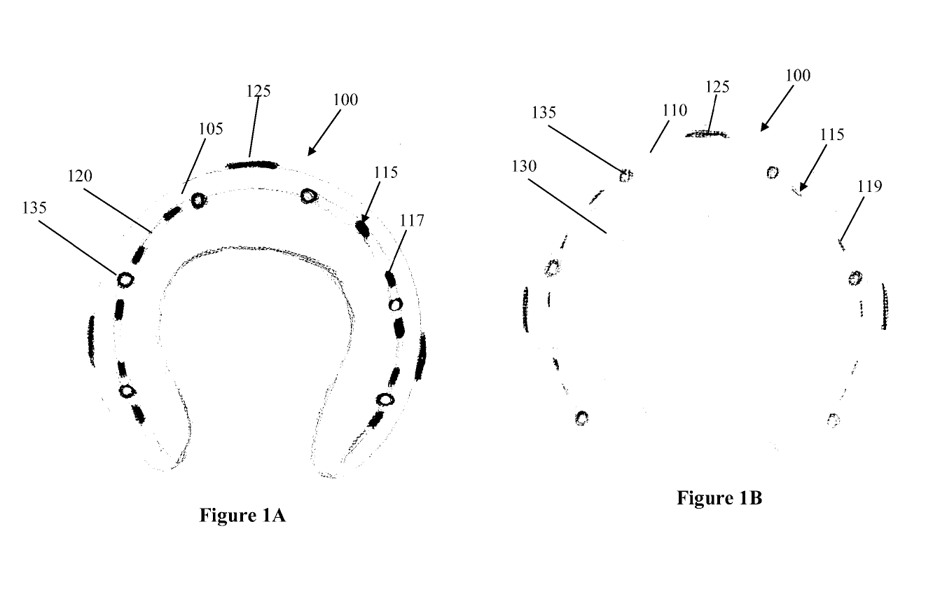

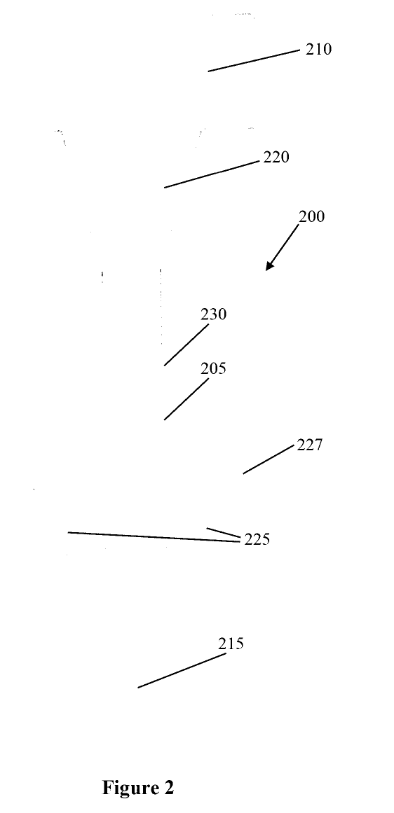

FIGS. 1A and 1B show a horseshoe (100) according to an embodiment of the present invention for use with or when used with a nail (200; i.e., a mechanical fastener) as shown in FIG. 2, which is used to fasten the horseshoe (100) to the hoof of a horse.

Referring to FIGS. 1A and 1B, the horseshoe (100) has the shape of a conventional horseshoe, that is, a band of material in the form of an extended arc configured to be attached to an outer hoof wall of a horse at any one of a toe, quarter and heel portion of the hoof. The horseshoe (100) is formed from polyurethane, which, in addition to providing some shock absorption, advantageously allows the horseshoe (100) to, in use, flex with the natural lateral flexing and widening of the hoof when under load.

The horseshoe (100) has a ground engaging face (105; best shown in FIG. 1A), a hoof engaging face (110; best shown in FIG. 1B), and includes a plurality of apertures (115) spaced along a length of the horseshoe (100) for receiving nails for attaching the horseshoe (100) to a hoof.

The apertures (115) are aligned and spaced along the length of the horseshoe (100) in an arc with a degree of curvature similar to or the same as that of the horseshoe (100). The horseshoe (100) includes 10 apertures (115) positioned for attaching the horseshoe (100) to any one of the toe, quarter and heel portions of a hoof of a horse.

Each aperture (115) extends through both the ground engaging face (105) and hoof engaging face (110) of the horseshoe (100) and is defined by an entrance opening (117) on the ground engaging face (105) and a corresponding exit opening (119) on the hoof engaging face (110) of the horseshoe (100).

Referring to FIG. 1A, the apertures (115), in particular the entrance openings (117) of the apertures (115), are located within a fuller (120; i.e., at least one channel or trench), which is defined in and extends in an arc in the ground engaging face (105) of the horseshoe (100). The fuller (120) is 4 mm deep, which ensures the heads of the nails (not shown) used to attach the horseshoe (100) to a hoof of a horse at least sit flush with the ground engaging face (105).

The horseshoe (100) further includes three clips (125) configured to lie or abut against an upper hoof surface and facilitate in the fitting and positioning of the horseshoe (100) on a hoof. The horseshoe (100) includes a single clip (125) for engaging with an upper hoof surface above a toe portion of the hoof and two side clips (125) each for engaging with the upper hoof surface above the quarter portion of the hoof.

Referring to FIG. 1B, the horseshoe (100) further includes a channel (130) on the hoof engaging face (110) of the horseshoe (100) to facilitate in the distribution of glue (i.e., a chemical fastener) for use in conjunction with the nails for attaching the horseshoe (100) to a hoof of a horse and/or to facilitate in the distribution of shock absorbing gel (i.e., a flowable shock absorber).

The channel (130) extends across a substantial portion of the hoof engaging face (110) of the horseshoe (100), including the toe, quarter and heel engaging portions of the horseshoe (100). The channel (130) extends in an arc along a length of the horseshoe (100) with a degree of curvature similar to or the same as that of the horseshoe (100).

The channel (130) has a U-shaped profile or cross section with a depth of about 2 mm and a width at the hoof engaging face (110) of about 10 mm (excluding the portions of the channel that extend between the apertures (115) to an outer edge of the horseshoe (100)).

The channel (130) is in fluid communication with six injection ports (135) accessible from the ground engaging face (105) of the horseshoe (100). Each injection port (135) is for injecting glue and/or shock absorbing gel into the channel (130) once the horseshoe (100) has been fitted to a hoof of a horse. Each injection port (135) is adapted to receive glue or shock absorbing gel provided in a syringe dispenser.

Best shown in FIG. 1A, the injection ports (135) are located in the fuller (120) together with the entrance openings (117) of the apertures (115).

FIG. 2 shows a side view of a nail (200) according to an embodiment of the present invention for fastening the horseshoe shown in FIGS. 1A and 1B to a hoof of a horse.

The nail (200) is of a length and shape that, in use, does not need to be clinched and does not emerge from an upper side of a hoof of a horse. This advantageously allows the nail (200) to be used at a heel portion of the hoof. The nail (200) has a length of about 24 mm and is formed from steel.

As shown in FIG. 2, the nail (200) includes: a shank (205); an enlarged head (210) at one end of the shank (205); a pointed end (215) at the other end of the shank (205); a neck portion (220) adjacent the enlarged head portion (210), which tapers in thickness from the enlarged head portion (210) to the shank (205); and a pair of opposed barbs (225; i.e., retentions members) extending from opposite sides of the shank (205) at the pointed end (215).

In use, the pointed end (215) and the pair of opposed barbs (225) are sized and shaped to pass through an aperture of the horseshoe and be driven into a hoof of a horse. Likewise, the enlarged head (210) is sized and shaped to not pass through the aperture of the horseshoe but instead abut against the ground engaging face of the horseshoe to thus hold the horseshoe to the hoof of a horse. The neck portion (220) is configured to be wedged in the aperture of the horseshoe when the nail (200) is driven into a hoof of a horse.

Each barb (225) includes a rearwardly facing point (227) that, once the nail (200) is driven into a hoof of a horse, engages with hoof material thereby facilitating the nail (200) in at least resisting withdrawal or retraction of the nail (200) from the hoof. Advantageously, this holds the nail (200) in place and eliminates the need to clinch the nail (200).

As indicated above, the nail (200) is formed from steel. Specifically, the nail (200) is laser cut from plate steel of about 3 mm in thickness. Consequently, the nail (200) is substantially flat or planar in a first orientation with a thickness of about 3 mm. In this orientation, the nail (200) is characterised by the two opposed surfaces of the plate steel from which it is cut, which are substantially parallel to one another and interconnected by opposing edge portions (230). The edge portions (230) in a second orientation, when the nail (200) is rotated around its longitudinal axis relative to the first orientation (as shown in FIG. 2), define the shank (205), the enlarged head (210), the pointed end (215), the neck portion (220) and the pair of opposed barbs (225).

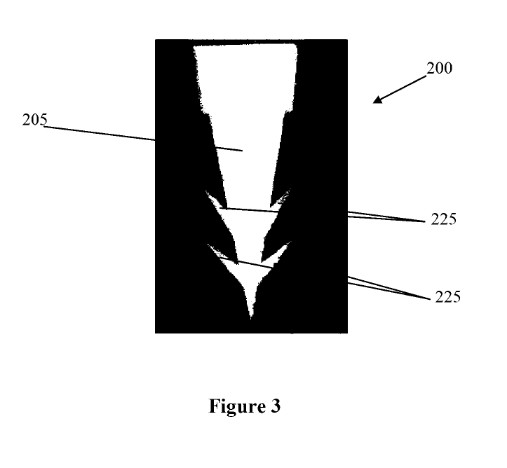

FIG. 3 shows another embodiment of the nail (200) in which the nail (200) includes a second pair of opposed barbs (225) located along the shank (205) of the nail (200) adjacent the first pair of barbs (225).

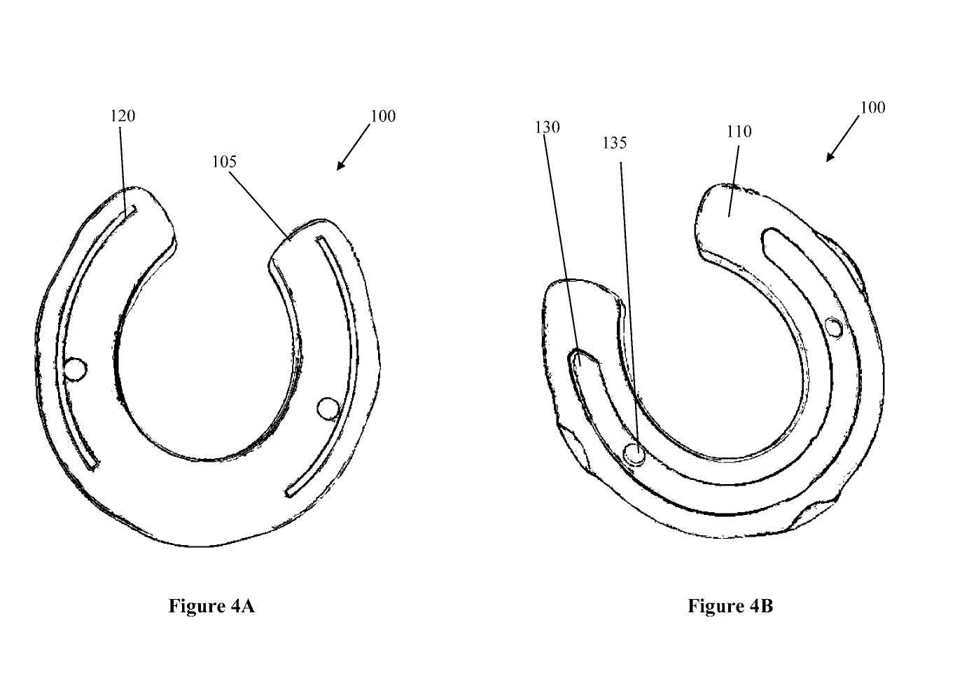

FIGS. 4A and 4B show another embodiment of the horseshoe (100), in which the horseshoe is formed from metal.

As with the previously described embodiment, the horseshoe (100) shown in FIGS. 4A and 4B has a ground engaging face (105; shown in FIG. 4A) and a hoof engaging face (110; shown in FIG. 4B).

Referring to FIG. 4A, the ground engaging face (105) of the horseshoe (100) defines a fuller (120) in which apertures (not shown) are located for receiving nails for attaching the horseshoe (100) to a hoof of a horse. The fuller (120) is 4 mm deep, which ensures the heads of the nails used to attach the horseshoe (100) to a hoof of a horse at least sit flush with the ground engaging face (105).

Adjacent the fuller (120) are located two injection ports (135). Each injection port (135) is for injecting shock absorbing gel into the channel (130) defined on the hoof engaging face (110) of the horseshoe (100) once the horseshoe (100) has been fitted to a hoof of a horse. Each injection port (135) is adapted to receive the shock absorbing gel provided in a syringe dispenser.

Referring to FIG. 4B, the channel (130) defined on the hoof engaging face (110) of the horseshoe (100) extends in an arc along a length of the horseshoe (100) with a degree of curvature similar to or the same as that of the horseshoe (100).

The channel (130) has a U-shaped profile or cross section with a depth of 2 mm and a width at the hoof engaging face (110) of 10 mm.

The channel (130) is in fluid communication with the two injection ports (135) accessible from the ground engaging face (105) of the horseshoe (100).

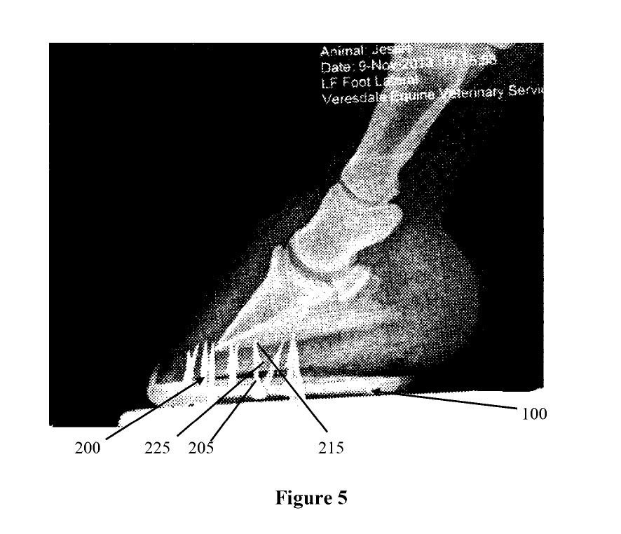

FIG. 5 is an X-ray image of the horseshoe (100) as shown in FIGS. 1A and 1B nailed to a hoof of a horse with nails (200) according to an embodiment of the present invention.

In this embodiment, each nail (200) has a single barb (225) extending from a side of the shank (205).

The X-ray image shows that, advantageously, the pointed ends (215) of the nails (200) are clearly embedded in the hoof of the horse and do not penetrate or emerge from an upper side of the hoof.

A method of shoeing a horse using the horseshoe (100) is now briefly described.

Prior to shoeing a hoof of a horse, an old horseshoe if present is removed and the hoof is cleaned and trimmed. In particular, the outer hoof wall is trimmed back to a desired length.

The horseshoe (100) is then aligned to the outer hoof wall and fixed in place optionally by hammering one or more nails (200) through apertures (115) at the toe portion and the heel portion of the hoof.

If the hoof is of poor quality or quantity, glue and/or a shock absorbing gel can be injected by way of a syringe dispenser between the hoof and the horseshoe (100) via one or more of the injection points (135) located on the ground engaging face (105) of the horseshoe (100). The channel (130) on the hoof engaging face (110) of the horseshoe (100) facilitates in dispersing the injected glue and/or shock absorbing gel along the hoof engaging face (110) between the horseshoe (100) and the hoof.

The horseshoe (100) is then securely nailed in place by hammering one or more nails (200) in apertures (115) located at any one of the toe, quarter and heel portions of the hoof.

Advantages of the present invention as exemplified include:
the nail, which is not driven through an upper surface of a horse's hoof, is not clinched and in no way damages the upper side of the hoof, which collectively, in turn, results in a healthier and stronger hoof for future reshoeing;
as the nail is not driven through the upper surface of a horse's hoof, most damage caused by the nail is typically removed prior to the horse being reshoed when the outer hoof wall is trimmed back;
additionally, as the nail is not driven through the upper surface of a horse's hoof, less hammering is required, which, apart from being beneficial for young, irregularly shod, injured or sensitive horses, also reduces the time taken to reshoe a horse;
the nail, due to its shorter length, enables the horseshoe of the present invention to be fastened to a heel portion of the hoof, which, in turn, results in a horseshoe that is at one with the hoof and does not impede lateral flexing and widening of the hoof when loaded; and
the channel and injection ports of the horseshoe allow the horseshoe to be used as a remedial horseshoe in which any hoof damage or imperfections can be corrected with glue and/or a shock absorbing gel dispersed via the injection ports and channel after the horseshoe has been fitted to the hoof.

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1-20. (canceled)

21. A horseshoe attachable to a hoof of a horse and adapted to allow lateral flexing and widening of the hoof, the horseshoe comprising:
a hoof engaging face and a ground engaging face, wherein the horseshoe is formed from a rubber or plastic material.

22. The horseshoe of claim 21, wherein the hoof engaging face and the ground engaging face are substantially U-shaped.

23. The horseshoe of claim 21, wherein the horseshoe is formed from polyurethane.

24. The horseshoe of claim 21, wherein the horseshoe comprises between 4 and 12 apertures extending through the ground engaging face and the hoof engaging face, said apertures located near to an outer edge of the horseshoe.

25. The horseshoe of claim 24, wherein the openings of the apertures on the ground engaging face are located in at least one channel that extends in an arc along the ground engaging face, wherein the channel has a depth of between 1 and 10 mm.

26. The horseshoe of claim 21, wherein the hoof engaging face comprises at least three raised outer rim or edge portions configured to abut against an upper hoof surface and facilitate in the fitting and positioning of the horseshoe on a hoof.

27. The horseshoe of claim 26, wherein two of the three portions are positioned to abut against the upper hoof surface towards a heel from a quarter portion of the hoof.

28. The horseshoe of claim 21, wherein the hoof engaging face comprises at least one channel to facilitate in the distribution of a chemical fastener and/or a flowable shock absorber between the hoof and the horseshoe, and at least at least one injection port accessible from the ground engaging for injecting chemical fastener and/or a flowable shock absorber into the at least one channel.

29. A horseshoe assembly comprising:
a horseshoe attachable to a hoof of a horse and adapted to allow lateral flexing and widening of the hoof, said horseshoe comprising a hoof engaging face and a ground engaging face and being formed from a plastic or rubber material; and
a fastening mechanism for fastening the horseshoe to at least a toe portion and a heel portion of the hoof, the fastening mechanism including mechanical fasteners and/or chemical fasteners.

30. The assembly of claim 29, wherein the horseshoe is formed from polyurethane.

31. The horseshoe assembly of claim 29, wherein the horseshoe comprises at least one channel on the hoof engaging face and at least one injection port on the ground engaging face in fluid communication with the at least one channel, and the assembly further includes a flowable shock absorber formulated to be injected into the at least one channel via the at least one injection port once the horseshoe has been fitted to the hoof.

32. The assembly of claim 29, wherein the fastening mechanism includes both mechanical fasteners and chemical fastener, and wherein the chemical fastener is formulated to be injected into at least one channel on the hoof engaging face via at least one injection port on the ground engaging face.

33. The assembly of claim 31, wherein the at least one channel extends at least partway along a length of the length of the horseshoe near or along an inner edge of the horseshoe such that the flowable shock absorber received in the channel can escape via the inner edge of the horseshoe.

34. The assembly claim 32, wherein the at least one channel extends at least partway along a length of the length of the horseshoe near or along an inner edge of the horseshoe such that chemical fastener received in the channel can escape via the inner edge of the horseshoe.

35. The assembly of claim 29, wherein the mechanical fasteners, in use, do not need to be clinched and do not emerge from an upper side of the hoof.

36. The assembly of claim 29, wherein each mechanical fastener includes a shank, an enlarged head at one end of the shank, a pointed end at an opposite end of the shank and at least one retention member extending from the side of the shank.

37. The assembly of claim 36, wherein the pointed end is sized and shaped to pass through an aperture of the shoe and be driven into the hoof; and the enlarged head is sized and shaped to abut against a ground engaging face of the horseshoe and retain the horseshoe against the hoof of the horse.

38. The assembly of claim 36, wherein the at least one retention member is in the form of a barb, spike or projection located at or near the pointed end of the mechanical fastener, wherein the barb, spike or projection expands from the pointed end of the mechanical fastener to a point that is rearwardly facing or at least orthogonally positioned relative to a longitudinal axis of the mechanical fastener.

39. A method of shoeing a horse, comprising the step of:
fastening a horseshoe to at least a toe portion and a heel portion of a hoof of a horse, wherein a hoof engaging portion of the horseshoe is positioned against the hoof, and a ground engaging portion of the horseshoe is positioned opposite the hoof engaging portion, and wherein the horseshoe is adapted to allow lateral flexing and widening of the hoof and formed from a rubber or plastic material.

40. A method of shoeing a horse, comprising the steps of:
(i) obtaining a horseshoe assembly including: a horseshoe attachable to a hoof of a horse and adapted to allow lateral flexing and widening of the hoof, the horseshoe comprising a hoof engaging face and a ground engaging face and being formed from a plastic or rubber material; and a fastening mechanism for fastening the horseshoe to at least a toe portion and a heel portion of the hoof, the fastening mechanism including mechanical fasteners and/or chemical fasteners; and
(ii) fastening the horseshoe to at least a toe portion and a heel portion of a hoof of a horse, wherein the hoof engaging portion of the horseshoe is position against the hoof, and a ground engaging portion of the horseshoe is positioned opposite the hoof engaging portion.
